(19) United States
(12) Patent Application Publication
(10) Pub. No.: US 2021/0114436 A1
(43) Pub. Date: Apr. 22, 2021

(54) SYSTEM FOR MOUNTING AN AIR CONDITIONING COMPRESSOR FROM AN EARLIER MODEL VEHICLE TO A LATER MODEL ENGINE

(71) Applicant: Darrin Gartrell, Woodward, OK (US)

(72) Inventor: Darrin Gartrell, Woodward, OK (US)

(21) Appl. No.: 16/657,322

(22) Filed: Oct. 18, 2019

(51) Int. Cl. B60H 1/32; F02B 67/06; F02B 75/22; F02B 63/06; F16H 7/02; F16H 7/12

(52) U.S. Cl. CPC B60H 1/3222; F02B 67/06; F02B 75/22; F02B 2075/1832; F16H 7/02; F16H 7/1281; F02B 63/06

(57) ABSTRACT

A mounting system configured to mount an air conditioning compressor to an engine. The mounting system adapted to mount a compressor to the engine to facilitate driving the air conditioning compressor with the engine via a pulley system disposed therebetween. A first member structured to couple to at least the engine and the first side of the compressor. A second member structured to couple to at least a second side of the compressor and a tensioner. The tensioner operatively engages the pulley system of the engine. A first layer of spacers intermediate to the first member and the engine. A second layer of spacers intermediate to the first member and the second member. The tensioner includes an interface that couples to a serpentine drive belt of the pulley system intermediate to the engine and the compressor.

### TECHNICAL FIELD OF THE DISCLOSED EMBODIMENTS

The presently disclosed embodiment generally relates to mounting accessories to an engine, and more particularly, to mounting an air conditioning compressor from an earlier model vehicle to a later model engine.

### BACKGROUND OF THE DISCLOSED EMBODIMENTS

Various owners of certain 1979-1995 model vehicles desire to install a later model engine into these vehicles. Popular later model engines include the LS engines installed as original equipment (“OEM”) in General Motors vehicles between model years 2000-2013 and a portion of 2014. Some benefits of using the later model LS engines over the OEM 1979-1995 vehicle engines include increased reliability, updated ignition and electronics, fuel injection, increased fuel economy, and better overall performance. Despite the owners' desire to install the later model engines into their 1979-1995 vehicles, many owners wish to retain their vehicles' OEM accessories like air conditioning compressors, master cylinders, and/or power-steering pumps. In their OEM applications, however, some of these later model engines, like the LS engines found in General Motors vehicles employ an air conditioning compressor that is different than the OEM air conditioning compressors on the 1979-1995 vehicles. Additionally, these later model LS motors mount the air conditioning compressor to the bottom of the engine, while the 1979-1995 vehicles typically originally installed the air conditioning compressor at a location toward the top of the OEM motor. In this configuration the later model LS engine cannot be installed into these earlier model vehicles without making substantial structural modifications to the vehicle. Accordingly, there is a need to install the air conditioning compressor in a new location on the later model motors so that the engine may fit more readily within the engine compartment space of the earlier model vehicles. The present invention is directed toward meeting this need.

### SUMMARY OF THE DISCLOSED EMBODIMENTS

In one aspect of the present invention, a mounting system is used to mount an air conditioning (A/C) compressor to an engine. The mounting system includes a first member structured to couple to the engine and a first side of the compressor, and a second member structured to couple to at least a second side of the compressor. A first layer of spacers between the first member and the engine, and a second layer of spacers between the first member and the compressor, provide structural support for the compressor between the first and second members, and the first member and the engine. The first and second layers of spacers may include spacers of a plurality of lengths. A tensioner connected to the second member between the engine and the compressor operatively engages a serpentine drive belt of the engine's pulley system.

The combination of the engine, the first layer of spacers, the first member, the second layer of spacers, the compressor, and the second member are coupled together via a plurality of fasteners. The fasteners in the plurality of fasteners include a first end and a second end, the first end abuts a planar surface of the second member and the second end engages with the engine or a plurality of securing devices after passing through the first member. The plurality of fasteners includes fasteners of a plurality of lengths. The first and second members each include a first planar side and a second planar side. The first planar side of the first member abuts the engine and the first layer of spacers intermediate to the first planar side of the first member and the engine. The second planar side of the first member abuts the first side of the compressor and the second layer of spacers intermediate to the second planar side of the first member and the first planar side of the second member. The first planar side of the second member abuts the second side of the compressor and the second layer of spacers intermediate to the first planar side of the second member and the second planar side of the first member. The second planar side of the second member abuts a tensioner and the first end of the plurality of fasteners. The tensioner couples to the second planar side of the second member and includes an interface in operative engagement with the serpentine drive belt between the engine and the compressor. A structural support member optionally may further secure the first planar side of the first member to the engine via at least one of the plurality of fasteners with at least one of the plurality of spacers intermediate to the support member and the engine.

The mounting system is structured to mount a compressor to a type of engine known generally as a small-block V8, although the system disclosed herein may be configured to function with other models of engines. A serpentine drive belt is in operative engagement with the compressor, the V8 engine, and the tensioner. In one embodiment, the mounting system fits an OEM model R4 compressor, an aftermarket R4 compressor, or a compressor with like configuration, and is used to mount the R4 compressor to a small block V8.

The small block V8 used in this embodiment is the LS model engine manufactured by General Motors (GM) or an aftermarket LS engine or an engine with like configuration. When installed with air conditioning as OEM equipment in their original applications, the LS engines able to use this mounting system included an air conditioning compressor mounted to the bottom portion of the LS engine. By using the mounting system of the present invention, the compressor can be mounted to the top portion of the LS engine. Additionally, by using the mounting system of the present invention, the user may install an R4 or R4-style compressor on the later model LS or LS-style engine, in a location approximate to where the R4 or R4-style compressor was located in its OEM installation. The mounting system fits various LS engines, including LS engines with different offsets/drive spacing. This mounting system bolts to the same location on various LS engines. The offset and spacing references the distance used on the front drive of the LS engine. The crank pulley offsets/drive spacing may include the following offsets from the following OEM applications: Corvette crank pulley 2⅛″; Camaro crank pulley 2 15/16″; Truck/SUV crank pulley 3 11/16″; and 2010-2013 Camaro crank pulley 3 11/16″.

The mounting system of the present invention may be used to mount an A/C compressor from vehicle model years 1979 thru 1995 to an engine from vehicle model years 2000 thru 2013 and a portion of 2014. The mounting systems is a solution for replacing the original equipment A/C compressor on LS engines with an R4 compressor, and moving the compressor from a bottom portion of the engine to a top portion of the engine, so that the engine may be installed into earlier model vehicles with minimal modification to the vehicles.

### BRIEF DESCRIPTION OF DRAWINGS

The embodiments and other features, advantages, and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is an illustrative embodiment of a mounting system mounting a compressor to an engine;

FIG. 2 is a front perspective view of the mounting system of FIG. 1;

FIG. 3 is a rear perspective view of the mounting system of FIG. 1;

FIG. 4 is an exploded view of the mounting system of FIG. 1.

### DETAILED DESCRIPTION OF THE DISCLOSED EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated embodiments, and further applications of the principles of the invention as illustrated therein, as would normally occur to one skilled in the art to which the invention relates are contemplated hereby and desired to be protected. Such alternative embodiments require certain adaptations to the embodiments discussed herein that would be obvious to those skilled in the art.

An embodiment of a mounting system may include an A/C compressor bracket specifically designed to mount at least an R4 or R4-style A/C compressor, manufactured, by way of example and not limitation, under the following names: General Motors, Frigidaire, Delco, Harrison, Global, and Delphi. The automotive industry generally refers to this style and model compressor as an “R4” compressor, regardless of the specific manufacturer thereof. Examples of the R4 compressor may include a 7-inch diameter or a 7½-inch diameter housing. These compressors are original equipment on many models of General Motors vehicles at least from 1979 thru 1995 that use a single, serpentine belt-drive system. The R4 compressor is available with either a 4¼-inch pulley clutch or a 5-inch pulley clutch. The R4 compressor has approximately 10 cubic inches of displacement per revolution with four cylinders radiating from its crankshaft, making it ideal for installing with the GM LS engine model. The mounting system nay use a spring-lever tensioning assembly, for example, from a 1999 to 2006 Jeep with a 4.0 L engine. This may allow mounting the compressor 7 inches from the engine center-line of the small block V8, which may eliminate the need for an upper idler assembly and decreasing the serpentine drive belt length.

The mounting system is structured to mount the compressor to the top portion of the engine so that the mounted compressor fits within the engine compartment of the 1979-1995 model vehicle and so that the mounted compressor is proximate to its OEM location said vehicle. The mounting system may be used to install a GM LS or LSX based engine into various makes and models of cars and trucks that predate model year 2000 and, in particular, that comprise model years 1979 thru 1995. The mounting system may include a combination of plates, spacers, bolts, a rear support brace, and a tensioning assembly with a slotted rear cam plate to aid in adjustments for various drive belt lengths of various accessory pulley sizes and combinations.

The mounting system may fit various LS engines, including LS engines with, for example, different offsets/drive spacing. The offset/drive spacing references the distance used on the front drive of the LS engine. The crank pulley offsets/drive spacing may include: Corvtte crank pulley 2⅛″; Camaro crank pulley 2 15/16″; Truck/SUV crank pulley 3 11/16″; and 2010-2013 Camaro crank pulley 3 11/16″. The mounting system of the present invention connects to the same location on the various LS engines. Adjusting the bolts and spacers of the mounting system provides the flexibility to use the mounting system on various LS engines and with various R4 compressors. The bolts may comprise a plurality of lengths including 25 mm, 45 mm, 70 mm, 110 mm, and 130 mm. The spacers may comprise a plurality of lengths including 0.725 in, 0.863 in, and 1.577 in.

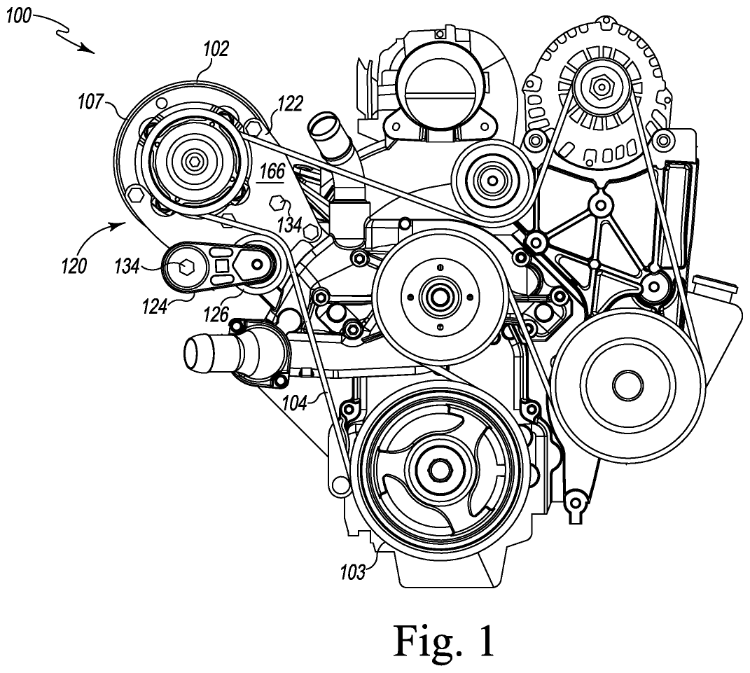

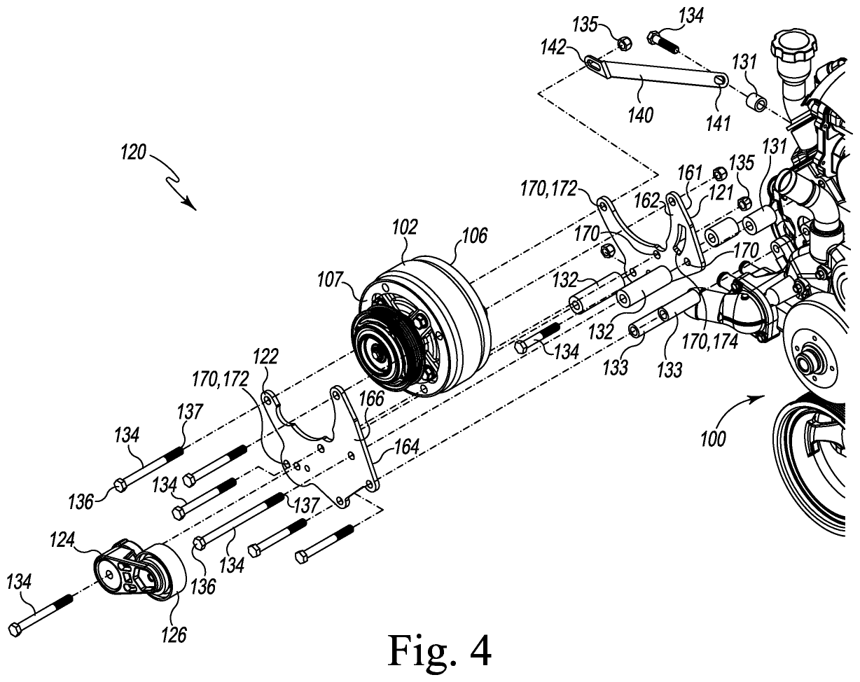

FIGS. 1-4 illustrate an embodiment of a mounting system 120 coupling an A/C compressor 102 to an engine 100, which, in the embodiment shown, is an internal combustion engine. Mounting system 120 may secure compressor 102 to engine 100. Engine 100 may be a small block V8 from vehicle model years including 2000 thru 2013 and/or a portion of 2014, as illustrated in FIG. 1. The mounting system 120 may include a first member 121 including a first planar side 161 and a second planar side 162, a second member 122 including a first planar side 164 and a second planar side 166, a first layer of spacers 131, a second layer of spacers 132, a third layer of spacers 133, a plurality of securing devices 135, a tensioner 124, and a plurality of fasteners 134, as illustrated in FIG. 4. The first member 121 and second member 122 may include a plurality of openings 170 along the first and second planar sides of each 161, 162, 164, 166. The plurality of openings may include holes 172, slots 174, and other types of openings known in the art, as illustrated in FIG. 4. The tensioner 124 may include an interface 126 to the vehicle pulley system 103, as illustrated in FIG. 1. The plurality of fasteners 134, as illustrated in FIG. 4, may include a first end 136 and a second end 137.

FIG. 4 illustrates the first member 121 structured to couple to a first side 106 of compressor 102. A second member 122 may be structured to couple to a second side 107 of compressor 102. The first layer of spacers 130 may be intermediate to first planar side 161 of first member 121 and engine 100, the second layer of spacers 131 may be intermediate to second planar side 162 of first member 121 and compressor 102, and the third layer of spacer 133 may be intermediate to the first planar side 164 of second member 122 and the engine 100. The first and second layers of spacers 130, 131 may include spacers of various lengths.

The vehicle pulley system 103, as illustrated in FIG. 1, may include a serpentine drive belt 104 that couples to engine 100, compressor 102, and tensioner 124. The serpentine drive belt 104 may couple to interface 126 intermediate to engine 100 and compressor 102. The first member 121 may couple to compressor 102, the first and second spacers 130, 131, second member 122, and engine 100 via the plurality of fasteners 134 of various lengths. The tensioner 124 may couple to the second member 122 via the plurality of fasteners 134.

The first planar side 161 of first member 121 may abut engine 100 and first layer of spacers 131 intermediate to first planar side 161 of first member 121 and engine 100. The second planar side 162 of first member 121 may abut first side 106 of compressor 102 and second layer of spacer 132 intermediate to second planar side 162 of first member 121 and first planar side 164 of second member 122. The first planar side 164 of second member 122 may abut second side 107 of compressor 102 and second layer of spacer 132 intermediate to first planar side 164 of second member 122 and second planar side 162 of first member 121. The second planar side 166 of second member 122 may abut tensioner 124 and first end 136 of the plurality of fasteners 134. The interface 126 of tensioner 124 may be in operative engagement with serpentine drive belt 104 between engine 100 and compressor 102.

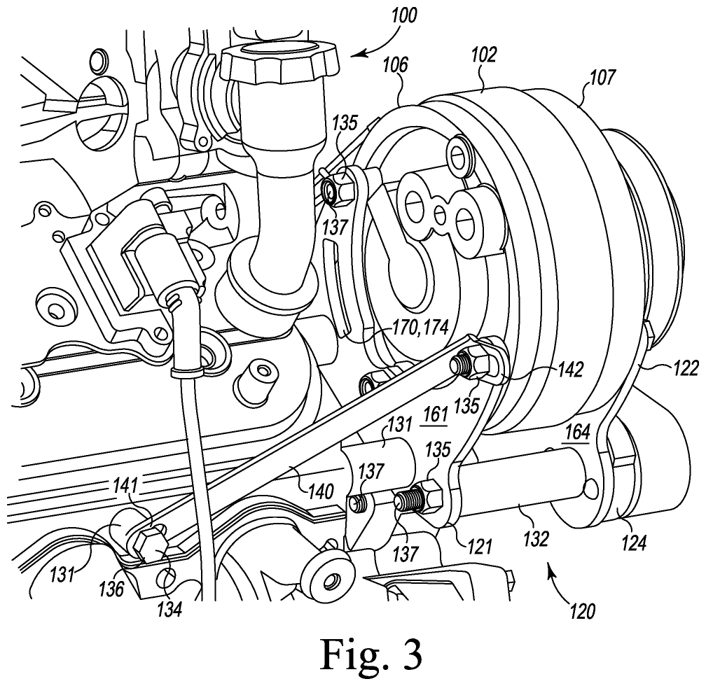

A structural support member 140 optionally may further secure first planar side 161 of first member 121 to engine 100, as illustrated in FIG. 3. The first end 141 of support member 140 may abut one of the first layer spacers 131 intermediate to first end 141 of support member 140 and engine 100. The second end 142 of support member 140 may abut first planar side 161 of first member 121 with or without at least one of the first layer spacers 131 intermediate to first planar side 161 of first support member 121 and the second end 142 of support member 140.

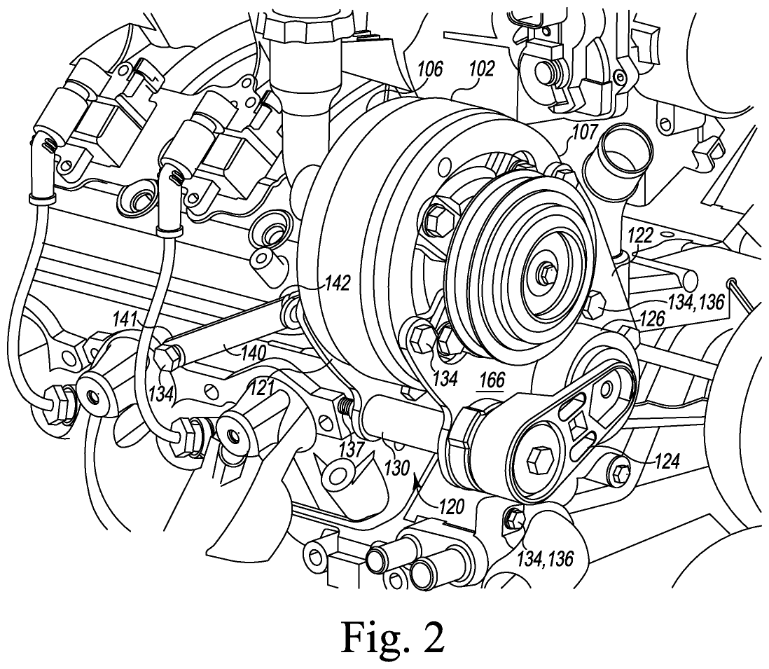

When the plurality of fasteners 134 are installed in accordance with the present invention, as illustrated in FIGS. 2 and 3, the first end 136 may abut the second planar side 166 of second member 122 and the second end 137 may engage with engine 100 (not shown) or the one or more securing devices 135 after passing through the first member 121 via the openings 170, for example holes 172 or slots 174, and some of the first layer of spacers 131, as illustrated in FIG. 4.

While the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

What is claimed is:

1. A mounting system adapted to mount a compressor to an engine so as to facilitate the driving of the compressor by the engine via a pulley system disposed therebetween, the mounting system comprising:
a first member, the first member includes a first planer side and a second planar side with a plurality of openings therethrough, and is structured to couple to at least the engine and a first side of the compressor;
a second member, the second member includes a first planar side and a second planar side with a plurality of openings therethrough, and is structured to couple to at least a second side of the compressor;
a first layer of spacers are intermediate to the first planar side of the first member and the engine;
a second layer of spacers are intermediate to the second planar side of the first member and the first planar side of the second member;
a tensioner, the tensioner couples to the second planar side of the second member, and operatively engages the pulley system intermediate to the engine and the compressor;
a plurality of fasteners, the plurality of fasteners comprise a plurality of lengths, a first end and a second end; and
a plurality of securing devices, the plurality of securing devices couple to at least one of the plurality of fasteners;
wherein the compressor and the second layer of spacers are intermediate to the second planar side of the first member and the first planar side of the second member;
wherein the combination of the engine, the first layer of spacers, the first member, the second layer of spacer, the compressor, the second member, and the tensioner all couple together via the plurality of fasteners, the second end of the plurality of fasteners either engage with the engine or the plurality of securing devices after passing through the plurality of openings in the first member or after passing through the plurality of openings in the first member and at least some of the first layer of spacers.

2. The mounting system according to claim 1, wherein at least the first end of the plurality of fasteners abuts the second side of the second member and the second end of at least one of the plurality of fasteners passes through the openings in the second member, the compressor, the first member, or some of the first layer of spacers and engages with the engine or some of the plurality of securing devices;

3. The mounting system according to claim 1, wherein at least the first end of at least one of the plurality of fasteners abuts the second planar side of the second member and the second end of at least one of the plurality of fasteners pass through the openings in the second member, some of the second layer of spacers, the openings in the first member, some of the first layer of spacers and engages with the engine or some of the plurality of securing devices.

4. The mounting system according to claim 1, wherein the plurality of openings comprises holes and slots.

5. The mounting system according to claim 1 wherein the interface of the tensioner is in operative engagement with a serpentine drive belt coupled to the engine and the compressor.

6. The mounting system according to claim 1, wherein the first planar side of the first member abuts the engine and the first layer of spacers intermediate to the first planar side of the first member and the engine at a plurality of locations along a surface of the first planar side of the first member.

7. The mounting system according to claim 1, wherein the second planar side of the first member abuts the first side of the compressor and the second layer of spacers intermediate to the second planar side of the first member and the first planar side of the second member at a plurality of locations along a surface of the second planar side of the first member.

8. The mounting system according to claim 1, wherein the first planar side of the second member abuts the second side of the compressor and the second layer of spacers intermediate to the first planar side of the second member and the second planar side of the first member at a plurality of locations along a surface of the first planar side of the second member.

9. The mounting system according to claim 1, further comprising a third layer of spacers intermediate to the first planar side of the second member and the engine.

10. An engine system, the engine system comprising:
an engine, the engine configured as an internal combustion engine;
a compressor, the compressor configured as an air conditioning compressor;
a pulley configuration, the pulley configuration includes a drive belt in operative engagement with the engine and the compressor;
a mounting system adapted to mount the compressor to the engine so as to facilitate the driving of the compressor by the engine via the pulley configuration disposed therebetween, the mounting system comprising:
a first member, the first member includes a first planer side and a second planar side with a plurality of openings therethrough, and is structured to couple to at least the engine and a first side of the compressor;
a second member, the second member includes a first planar side and a second planar side with a plurality of openings therethrough, and is structured to couple to at least a second side of the compressor;
a first layer of spacers are intermediate to the first planar side of the first member and the engine;
a second layer of spacers are intermediate to the second planar side of the first member and the first planar side of the second member;
a tensioner, the tensioner couples to the second planar side of the second member, and operatively engages the pulley system intermediate to the engine and the compressor;
a plurality of fasteners, the plurality of fasteners comprise a plurality of lengths, a first end and a second end; and
a plurality of securing devices, the plurality of securing devices couple to at least one of the plurality of fasteners;
wherein the compressor and the second layer of spacers are intermediate to the second planar side of the first member and the first planar side of the second member;
wherein the combination of the engine, the first layer of spacers, the first member, the second layer of spacer, the compressor, the second member, and the tensioner all couple together via the plurality of fasteners, the second end of the plurality of fasteners either engage with the engine or the plurality of securing devices after passing through the plurality of openings in the first member or after passing through the plurality of openings in the first member and at least some of the first layer of spacers.

11. The engine system according to claim 9 wherein the internal combustion engine includes a small block V8.

12. The engine system according to claim 9 wherein the first and second sets of spacers are structured to support mounting the front portion and the back portion to the compressor and the small block V8 via some of the plurality of fasteners and some of the securing devices.

13. The engine system according to claim 9 wherein the drive belt is a serpentine drive belt.

14. The engine system according to claim 9 wherein the compressor is a model R4 compressor or an aftermarket model R4 compressor or a compressor with like configuration.

15. The engine system according to claim 13 wherein the mounting system is structured to couple the compressor to the small block V8, wherein the small block V8 is a LS model engine manufactured by General Motors or an aftermarket LS engine or an engine with like configuration.

16. An apparatus for mounting a compressor to an internal combustion engine, the apparatus comprising:
a first means for securing a first side of the compressor to the internal combustion engine;
a second means for securing a second side of the compressor to the internal combustion engine;
a first spacer means disposed between the compressor and the first means;
a second spacer means disposed between the first means and the internal combustion engine;
a tensioning means operatively engages a serpentine drive belt intermediate to the internal combustion engine and the compressor;
a fastening means for securing the first means to the first side of the compressor and the internal combustion engine, and the second means to the second side of the compressor and the tensioning means.

17. The apparatus of claim 16, wherein the internal combustion engine is a small block V8.

18. The apparatus of claim 16 wherein, the serpentine drive belt interfaces the compressor and the small block V8.

19. The apparatus of claim 16, wherein the compressor is a model R4 compressor or an aftermarket R4 compressor or a compressor having a like configuration.

20. The apparatus of claim 20, wherein the apparatus is structured to couple the model R4 compressor to the small block V8, wherein the small block V8 is a LS model engine manufactured by General Motors or an aftermarket LS engine or an engine with like configuration.
